(19) United States
(12) Patent Application Publication
(10) Pub. No.: US 2008/0107180 A1
(43) Pub. Date: May 8, 2008

(54) METHOD AND APPARATUS FOR VIDEO PREDICTIVE ENCODING AND METHOD AND APPARATUS FOR VIDEO PREDICTIVE DECODING

(75) Inventors: Kyo-hyuk LEE, Yongin-si (KR); Duck-yeon KIM, Suwon-si (KR); Tammy LEE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/934,824

(22) Filed: Nov. 5, 2007

Related U.S. Application Data
(60) Provisional application No. 60/856,291, filed on Nov. 3, 2006.

(30) Foreign Application Priority Data
Jan. 4, 2007 (KR) 10-2007-0001164

(51) Int. Cl. H04N 7/32

(52) U.S. Cl. 375/240.16; 375/E07.123

(57) ABSTRACT

Provided are a method and apparatus for video predictive encoding and decoding, in which a prediction value of a current block is generated by using a motion vector, which is generated by motion estimation with respect to a neighboring area located adjacent to the current block, as a motion vector for the current block. The motion vector to be used for motion compensation with respect to the current block can be determined by motion estimation using a previously processed neighboring area without separate transmission of motion vector information regarding the current block, thereby reducing the amount of bits generated during encoding.

### CROSS-REFERENCE TO RELATED PATENT APPLICATIONS

This application claims priority from Korean Patent Application No. 10-2007-0001164 filed on Jan. 4, 2007 in the Korean Intellectual Property Office, and U.S. Provisional Patent Application No. 60/856,291 filed on Nov. 3, 2006 in the U.S. Patent and Trademark Office, the disclosures of which are incorporated herein in their entireties by reference.

### BACKGROUND OF THE INVENTION

1. Field of the Invention

Methods and apparatuses consistent with the present invention generally relate to video predictive encoding and decoding, and more particularly, to video predictive encoding and decoding, in which a prediction value of a current block is generated by using a motion vector, which is generated by motion estimation with respect to a neighboring area located adjacent to the current block, as a motion vector for the current block.

2. Description of the Related Art

In video encoding, compression is performed by removing spatial redundancy and temporal redundancy in a video sequence. To remove temporal redundancy, an area that is similar to an area of a current picture to be encoded is searched for in a reference picture by using a picture preceding or following the current picture as a reference picture, detecting the amount of movement between the area of the current picture and the found area of the reference picture, and encoding a residue between a prediction image obtained by motion compensation based on the detected amount of movement and a current image to be encoded.

Generally, a motion vector of a current block has a close correlation with a motion vector of a neighboring block. For this reason, in conventional motion estimation and compensation, the amount of bits to be encoded can be reduced by predicting a motion vector of the current block from the motion vector of a neighboring block and encoding only a difference between a true motion vector of the current block, which is generated by motion estimation with respect to the current block, and a prediction motion vector obtained from the neighboring block. However, also in this case, data corresponding to the difference between the true motion vector and the prediction motion vector has to be encoded for each block that is subject to motion-estimation encoding. Therefore, there is a need for a way to further reduce the amount of generated bits by efficiently performing predictive encoding on the current block.

### SUMMARY OF THE INVENTION

The present invention provides a method and apparatus for video predictive encoding and decoding, in which a prediction value of a current block is generated using motion information regarding a neighboring area located adjacent to the current block without separate transmission of motion information regarding the current block, thereby reducing the amount of information generated during video encoding.

According to one aspect of the present invention, there is provided a method for video predictive encoding. The method includes determining a motion vector indicating a corresponding area of a reference frame, which is similar to of a neighboring area located adjacent to a current block to be encoded, by performing motion estimation using the neighboring area of the current block, obtaining a prediction block of the current block from the reference frame using the determined motion vector of the neighboring area, and encoding a difference between the obtained prediction block and the current block.

According to another aspect of the present invention, there is provided an apparatus for video predictive encoding. The apparatus includes a motion estimation unit determining a motion vector of a neighboring area located adjacent to a current block to be encoded, which indicates a corresponding area of a reference frame, which is similar to the neighboring area, by performing motion estimation using the neighboring area of the current block, a motion compensation unit obtaining a prediction block of the current block from the reference frame using the determined motion vector of the neighboring area, and an encoding unit encoding a difference between the obtained prediction block and the current block.

According to still another aspect of the present invention, there is provided a method for video predictive decoding. The method includes identifying a prediction mode of a current block to be decoded by reading prediction mode information included in an input bitstream, if the prediction mode indicates that the current block has been predicted using a motion vector of a neighboring area located adjacent to the current block, determining a motion vector indicating a corresponding area of a reference frame, which is similar to the neighboring area, by performing motion estimation using the neighboring area of the current block, obtaining a prediction block of the current block from the reference frame using the determined motion vector of the neighboring area, and adding the prediction block of the current block to a difference between the current block and the prediction block, which is included in the bitstream, thereby decoding the current block.

According to still another aspect of the present invention, there is provided an apparatus for video predictive decoding. The apparatus includes a prediction mode identification unit identifying a prediction mode of a current block to be decoded by reading prediction mode information included in an input bitstream, a motion estimation unit determining a motion vector indicating a corresponding area of a reference frame, which is similar to a neighboring area located adjacent to the current block, by performing motion estimation using the neighboring area of the current block if the prediction mode indicates that the current block has been predicted using a motion vector of the neighboring area, a motion compensation unit obtaining a prediction block of the current block from the reference frame using the determined motion vector of the neighboring area, and a decoding unit adding the prediction block of the current block to a difference between the current block and the prediction block, which is included in the bitstream, thereby decoding the current block.

### BRIEF DESCRIPTION OF THE DRAWINGS

The above and other aspects of the present invention will become more apparent by describing in detail an exemplary embodiment thereof with reference to the attached drawings, in which:

FIG. 1 is a view for explaining a process of performing motion compensation on a current block using a method for video predictive encoding according to an exemplary embodiment of the present invention;

FIG. 2 is a block diagram of an apparatus for video predictive encoding according to an exemplary embodiment of the present invention;

FIG. 3 is a flowchart of a method for video predictive encoding according to an exemplary embodiment of the present invention;

FIG. 4 is a view for explaining a process of performing predictive encoding on a current frame using a method for video predictive encoding according to an exemplary embodiment of the present invention;

FIG. 5 illustrates processing a order of processing blocks using a method for video predictive encoding according to an exemplary embodiment of the present invention;

FIG. 6 is a view for explaining a process of performing predictive encoding on a block after the current block illustrated in FIG. 4, according to an exemplary embodiment of the present invention;

FIG. 7 is a view for explaining a process of performing predictive encoding on a block after the block illustrated in FIG. 6, according to an exemplary embodiment of the present invention;

FIG. 8 is a block diagram of an apparatus for video predictive decoding according to an exemplary embodiment of the present invention; and

FIG. 9 is a flowchart of a method for video predictive decoding according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. It should be noticed that like reference numerals refer to like elements illustrated in one or more of the drawings. In the following description of the exemplary embodiments of the present invention, a detailed description of known functions and configurations incorporated herein will be omitted for conciseness and clarity.

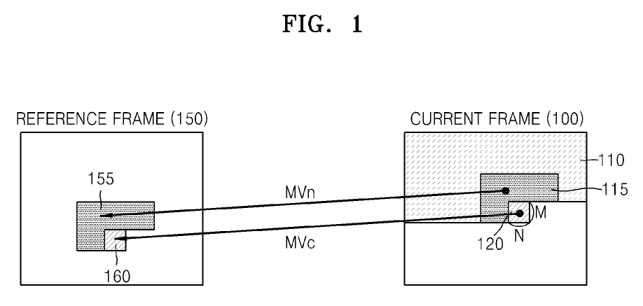

FIG. 1 is a view for explaining a process of performing motion compensation on a current block using a method for video predictive encoding according to an exemplary embodiment of the present invention. In FIG. 1, ‘120’ indicates a current block to be encoded, ‘110’ indicates a previous area composed of blocks that have been encoded and then reconstructed prior to the current block 120, and ‘115’ indicates a neighboring area, which is included in the previous area 110 and located adjacent to the current block 120.

In a related art, a motion vector is generated by performing motion estimation on the current block 120, and a difference between the generated motion vector and an average value or a median value of motion vectors of neighboring blocks located adjacent to the current block 120 is encoded as motion vector information of the current block 120. However, in this case, a difference between a true motion vector and a prediction motion vector has to be encoded for each block to be motion-estimation encoded and then has to be transmitted to a decoder.

In an exemplary embodiment of the present invention, a motion vector MVn generated by motion estimation with respect to the neighboring area 115 is used as a motion vector MVc of the current block 120 without motion estimation with respect to the current block 120. In the exemplary embodiment of the present invention, a corresponding area 160 of a reference frame 150, which is indicated by the motion vector MVc of the current block 120, is used as a prediction value (or prediction block) of the current block 120. When the motion vector MVn of the neighboring area 115 is used as the motion vector MVc of the current block 120, the decoder can generate the motion vector MVn of the neighboring area 115 using a result of performing motion estimation with respect the neighboring area 115 and then perform motion compensation using the generated motion vector MVn of the neighboring area 115 as the motion vector MVc of the current block 115 without receiving motion information regarding the current block 120, i.e., the difference between the motion vector of the current block 120 and the prediction motion vector.

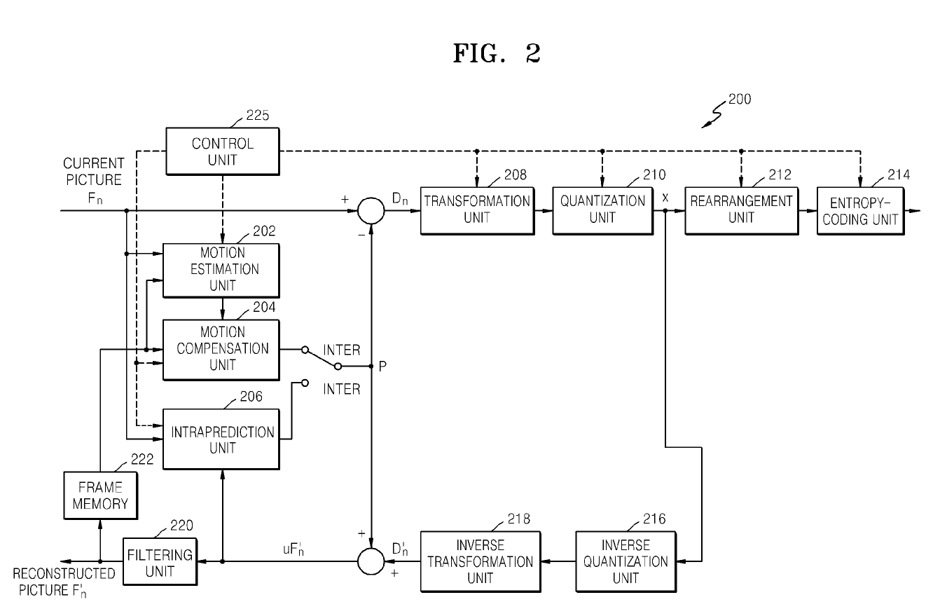

FIG. 2 is a block diagram of an apparatus 200 for predictive video encoding according to an exemplary embodiment of the present invention.

Referring to FIG. 2, the apparatus 200 for video predictive encoding includes a motion estimation unit 202, a motion compensation unit 204, an intraprediction unit 206, a transformation unit 208, a quantization unit 210, a rearrangement unit 212, an entropy-coding unit 214, an inverse quantization unit 216, an inverse transformation unit 218, a filtering unit 220, a frame memory 222, and a control unit 225.

The motion estimation unit 202 divides a current frame into blocks of a predetermined size, performs motion estimation with respect to a neighboring area that has been previously encoded and then reconstructed, and thus outputs a motion vector of the neighboring area. For example, referring back to FIG. 1, the motion estimation unit 202 performs motion estimation with respect to the neighboring area 115 that has been encoded and reconstructed prior to the current block 120 and then stored in the frame memory 222, thereby generating the motion vector MVn indicating a corresponding area 155 of the reference frame 150, which is most similar to the neighboring area 115 of the current frame 100. Here, the neighboring area means an area including at least one block that has been encoded and then reconstructed prior to the current block. According to a raster scan method, the neighboring area may include at least one block located above or to the left of the current block. The size and shape of the neighboring area may be various as long as they allow the neighboring area to include blocks that have been encoded and then reconstructed prior to the current block. However, in order to improve the accuracy of prediction with respect to the current block, it is preferable that the neighboring area be closely adjacent to the current block and have a small size.

The motion compensation unit 204 sets the motion vector of the neighboring area, generated by the motion estimation unit 202, as the motion vector of the current block, obtains data of the corresponding area of the reference frame, which is indicated by the motion vector of the current block, and generates the prediction value of the current block with the obtained data, thereby performing motion compensation. For example, referring back to FIG. 1, the motion compensation unit 204 sets a vector having the same direction and magnitude as those of the motion vector MVn of the neighboring area 115 of the current block 120 as the motion vector MVc of the current block 120. The motion compensation unit 204 also generates the corresponding area 160 of the reference frame 150, which is indicated by the motion vector MVc of the current block 120, as the prediction value of the current block 120.

The intraprediction unit 206 performs intraprediction by searching in the current frame for the prediction value of the current block.

Once the prediction block of the current block is generated by interprediction and intraprediction or motion compensation using the motion vector of the neighboring area according to the exemplary embodiment of the present invention, a residue corresponding to an error value between the current block and the prediction block is generated, and the generated residue is transformed into a frequency domain by the transformation unit 208 and then quantized by the quantization unit 210. The entropy-coding unit 214 encodes the quantized residue, thereby outputting a bitstream.

Quantized block data is reconstructed by the inverse quantization unit 216 and the inverse transformation unit 218. The reconstructed data passes through the filtering unit 220 that performs deblocking filtering and is then stored in the frame memory 222 in order to be used for prediction with respect to a next block.

The control unit 225 controls components of the apparatus 200 for video predictive encoding and determines a prediction mode for the current block. More specifically, the control unit 225 compares a cost between the prediction block generated by interprediction and the current block, a cost between the prediction block generated by intraprediction and the current block, and a cost between the prediction block generated using the motion vector generated by motion estimation with respect to the neighboring area according to the exemplary embodiment of the present invention and the current block, and determines a prediction mode having the minimum cost as a prediction mode for the current block. Here, cost calculation may be performed using various cost functions such as a sum of absolute difference (SAD) cost function, a sum of absolute transformed difference (SATD) cost function, a sum of squared difference (SSD) cost function, a mean of absolute difference (MAD) cost function, and a Lagrange cost function.

A flag indicating whether each block has been motion-compensated using a motion vector of its neighboring area may be inserted into a header of a bitstream to be encoded according to a method for video predictive encoding according to an exemplary embodiment of the present invention. The decoder can identify a prediction mode of the current block to be decoded using the inserted flag, generate the prediction value of the current block in the identified prediction mode, and add the prediction value to a difference included in the bitstream, thereby reconstructing the current block.

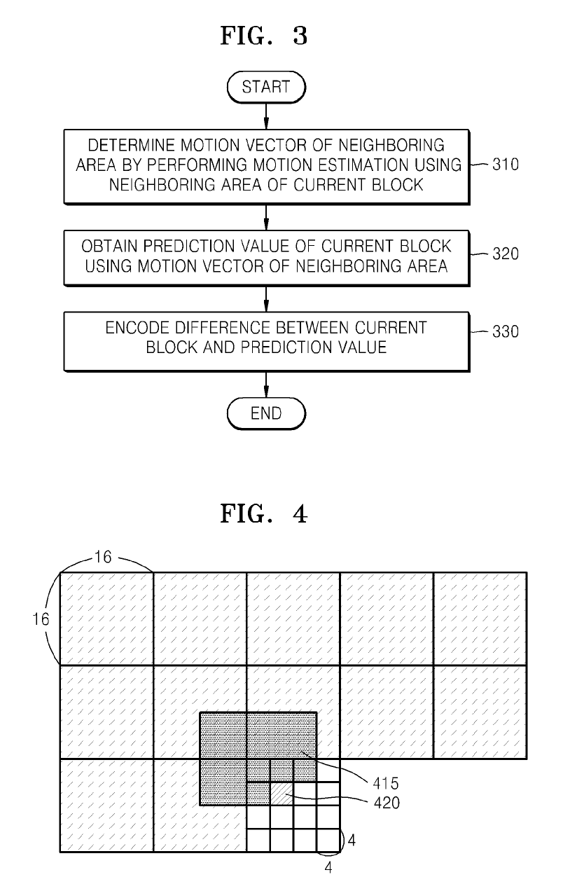

FIG. 3 is a flowchart of a method for video predictive encoding according to an exemplary embodiment of the present invention.

Referring to FIG. 3, motion estimation is performed on a neighboring area that has been encoded and then reconstructed prior to the current block to be encoded, thereby determining a motion vector of the neighboring area, which indicates a corresponding area of a reference frame that is most similar to the neighboring area, in operation 310.

In operation 320, the determined motion vector of the neighboring area is set as a motion vector of the current block and a prediction value of the current block is obtained using data of the corresponding area of the reference frame, which is indicated by the motion vector of the current block.

In operation 330, a bitstream is generated by transforming, quantizing, and entropy-coding a difference between pixels of the prediction value of the current block and pixels of the current block, and a predetermined flag indicating that each block has been encoded by prediction using the motion vector of the neighboring area is inserted into the bitstream.

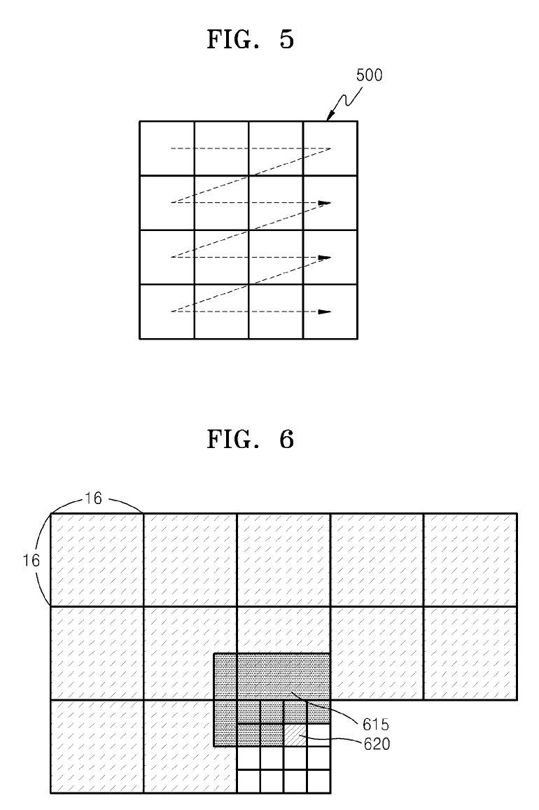

FIG. 4 is a view for explaining a process of performing predictive encoding on the current frame using the method for video predictive encoding according to the exemplary embodiment of the present invention, and FIG. 5 illustrates an order of processing blocks using the method for video predictive encoding according to the exemplary embodiment of the present invention. In FIG. 4, ‘420’ indicates the current block and ‘415’ indicates a neighboring area that has been previously encoded and then reconstructed prior to the current block 420.

It is preferable, but not necessary, that predictive encoding according to the exemplary embodiment of the present invention be performed in units of a block having the same size as a block size used during transformation, so as to use a reconstructed value of the current block in determining a motion vector of a next block. In other words, when an image is predictive-encoded in units of a block having the same size as a block sized used during transformation, a residue corresponding to a difference between the current block and a prediction block thereof is transformed and quantized prior to the completion of another block, and the transformed and quantized current block is reconstructed by being inversely transformed and inversely quantized in order to be used for prediction of a next block.

Referring to FIG. 4, if a residue corresponding to a difference between pixels of the current block and pixels of the prediction block is transformed into a frequency domain in units of a 4×4 block, a 16×16 macroblock may be divided into 4×4 blocks, and predictive coding according to the exemplary embodiment of the present invention may be performed in units of the 4×4 block. Once a motion vector indicating a corresponding area of a reference frame, which is most similar to a neighboring area 415, is determined by performing motion estimation with respect to the neighboring area 415, motion compensation is performed on the current block 420 using the motion vector of the neighboring area 415, without separate motion estimation with respect to the current block 420, in order to generate a prediction block of the current block 420 and a difference between the current block 420 and the generated prediction block is encoded.

The size and shape of the neighboring area 415 used to determine the motion vector of the current block 420 may be various. According to a raster scan method in which divided blocks 500 are encoded in the order from left to right and from top to bottom as illustrated in FIG. 5, the neighboring 415 may have various shapes and sizes as long as they allow the neighboring area 415 to include blocks that have been processed prior to the current block 420 and are located above or to the left of the current block 420.

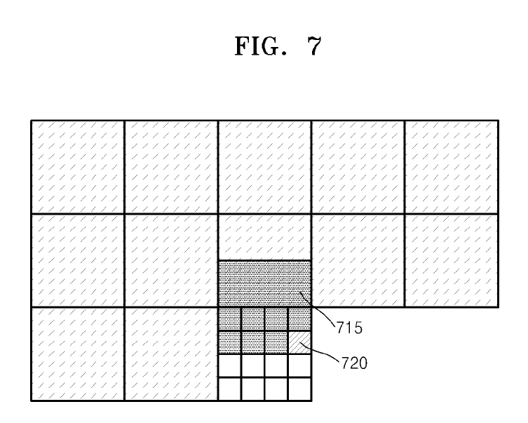

FIG. 6 is a view for explaining a process of performing predictive encoding on a block 620 after the current block 420 illustrated in FIG. 4, and FIG. 7 is a view for explaining a process of performing predictive encoding on a block 720 after the block 620 illustrated in FIG. 6.

Referring to FIG. 6, when the next block 620 of the current block 420 illustrated in FIG. 4 is processed, the neighboring area 415 is also shifted to the right by one block according to the raster scan method, and the next block 620 is predictive-encoded using the shifted neighboring area 615.

Referring to FIG. 7, when the next block 720 of the block 620 illustrated in FIG. 6 is processed, a neighboring area 715 obtained by shifting the neighboring area 615 illustrated in FIG. 6 to the right by one block may include a block that has not yet been processed. In this case, the size and shape of the neighboring area 715 used for predictive-encoding with respect to the block 720 have to be changed so that the neighboring area 715 only includes neighboring blocks that are located above or to the left of the block 720 and have been encoded and then reconstructed. As such, since available neighboring blocks that have been encoded and reconstructed vary according to the position of the current block to be encoded, it is desirable, but not necessary, for an encoder and a decoder to previously set the size and shape of an available neighboring area according to the position of the current block. In other words, since available neighboring blocks may vary with the relative position of the current block in a macroblock, the encoder and the decoder previously set the size and shape of an available neighboring area according to the position of the current block, thereby determining the neighboring area according to the position of the current block, and generating the prediction value of the current block without separate transmission of information regarding the neighboring area.

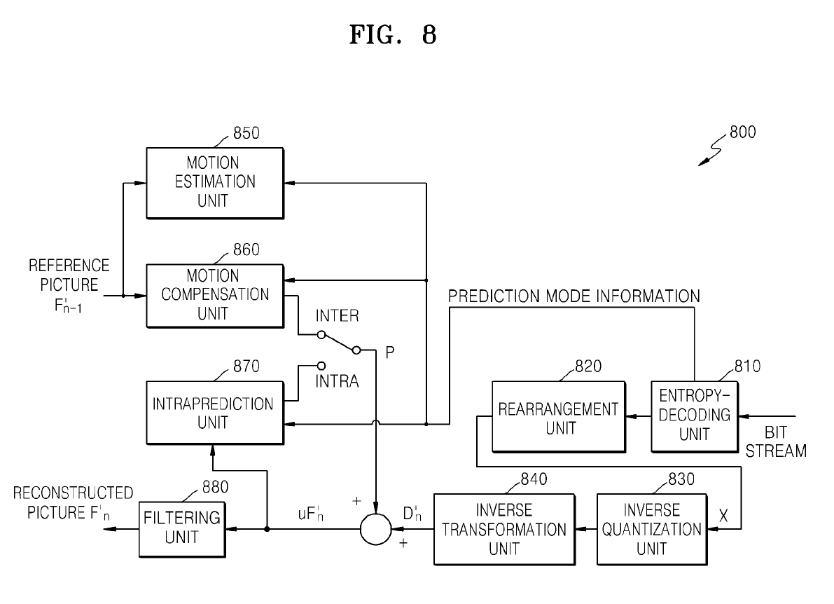

FIG. 8 is a block diagram of an apparatus 800 for video predictive decoding according to an exemplary embodiment of the present invention.

Referring to FIG. 8, the apparatus 800 for video predictive decoding according to an exemplary embodiment of the present invention includes an entropy-decoding unit 810, a rearrangement unit 820, an inverse quantization unit 830, an inverse transformation unit 840, a motion estimation unit 850, a motion compensation unit 860, an intraprediction unit 870, and a filtering unit 880.

The entropy-decoding unit 810 and the rearrangement unit 820 receive a bitstream and perform entropy-decoding on the received bitstream, thereby generating quantized coefficients. The inverse quantization unit 830 and the inverse transformation unit 840 perform inverse quantization and inverse transformation with respect to the quantized coefficients, thereby extracting transformation coding coefficients, motion vector information, and prediction mode information. Here, the prediction mode information may include a flag indicating whether the current block to be decoded has been encoded by motion compensation using a motion vector of a neighboring area without separate motion estimation according to the method for video predictive encoding according to the exemplary embodiment of the present invention. As mentioned above, motion estimation is performed on a neighboring area that has been decoded prior to the current block, and the motion vector of the neighboring area is used as the motion vector of the current block for motion compensation.

When the current block to be decoded has been predictive-encoded by motion compensation using the motion vector of the neighboring area according to the method for video predictive encoding of the exemplary embodiment of the present invention, without separate motion estimation, the motion estimation unit 850 determines the motion vector of the neighboring area by performing motion estimation on the neighboring area of the current block.

The motion compensation unit 860 operates in the same manner as the motion compensation unit 204 illustrated in FIG. 2. In other words, the motion compensation unit 860 sets the motion vector of the neighbor area generated by the motion estimation unit 850 as the motion vector of the current block, obtains data of a corresponding area of the reference frame, indicated by the motion vector of the current block, and generates the obtained data as the prediction value of the current block, thereby performing motion compensation.

The intraprediction unit 870 generates the prediction block of the current block using a neighboring block of the current block, which has been decoded prior to the intraprediction-encoded current block.

An error value D′n between the current block and the prediction block is extracted from the bitstream and is then added to the prediction block generated by the motion compensation unit 860 and the intraprediction unit 870, thereby generating reconstructed video data uF′n. uF′n passes through the filtering unit 880, thereby completing decoding on the current block.

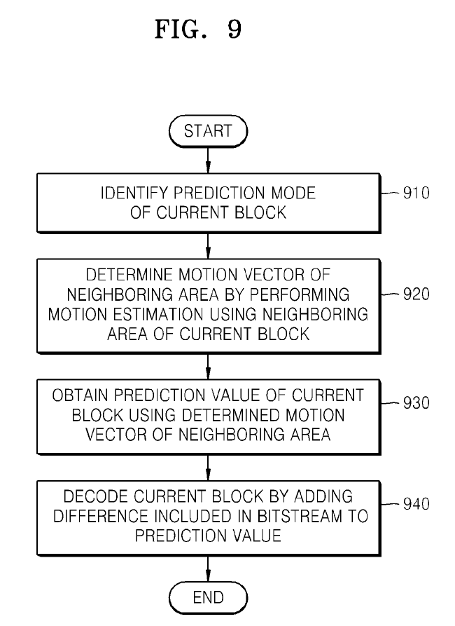

FIG. 9 is a flowchart of a method for video predictive decoding according to an exemplary embodiment of the present invention.

Referring to FIG. 9, prediction mode information included in an input bitstream is read in order to identify a prediction mode of the current block in operation 910.

In operation 920, if the prediction mode indicates that the current block has been predictive-encoded using a motion vector of a neighboring area without separate motion estimation, motion estimation is performed on the previously decoded neighboring area of the current block, thereby determining a motion vector indicating a corresponding area of a reference frame, which is most similar to the neighboring area.

In operation 930, the determined motion vector is determined as a motion vector of the current block, and the corresponding area of the reference frame indicated by the determined motion vector of the current block is obtained as the prediction value of the current block.

In operation 940, the prediction value of the current block and a difference between the current block and the prediction value, which is included in the bitstream, are added, thereby decoding the current block.

The exemplary embodiments of the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to the exemplary embodiment of the present invention, a motion vector to be used for motion compensation of the current block can be determined by performing motion estimation using a previously processed neighboring area without separately transmitting motion vector information regarding the current block, thereby reducing the amount of bits generated during encoding.

While the present invention has been particularly shown and described with reference to the exemplary embodiment thereof, it will be understood by those of ordinary skill in the art that various changes in form and detail may be made therein without departing from the spirit and scope of the present invention as defined by the following claims.

What is claimed is:

1. A method for video predictive encoding, the method comprising:
determining a motion vector of a neighboring area located adjacent to a current block to be encoded by performing motion estimation with respect to the neighboring area, wherein the motion vector of the neighboring area indicates a corresponding area in a reference frame which is similar to the neighboring area;
obtaining a prediction block of the current block from the reference frame using the motion vector of the neighboring area; and
encoding a difference between the prediction block and the current block.

2. The method of claim 1, wherein the obtaining the prediction block of the current block comprises:
setting the motion vector of the neighboring area as a motion vector of the current block which has a same magnitude and direction as that of the motion vector of the neighboring area; and
determining the corresponding area in the reference frame, which is indicated by the motion vector of the current block, as the prediction block of the current block.

3. The method of claim 1, wherein the neighboring area comprises at least one block that has been encoded and reconstructed prior to the current block.

4. The method of claim 1, further comprising inserting an identifier indicating that the current block has been encoded by prediction using the motion vector of the neighboring area into a given area of a bitstream resulting from encoding the difference between the current block and the prediction block.

5. An apparatus for video predictive encoding, the apparatus comprising:
a motion estimation unit that determines a motion vector of a neighboring area located adjacent to a current block to be encoded by performing motion estimation with respect to the neighboring area, wherein the motion vector of the neighboring area indicates a corresponding area in a reference frame which is similar to the neighboring area;
a motion compensation unit that obtains a prediction block of the current block from the reference frame using the motion vector of the neighboring area; and
an encoding unit that encodes a difference between the prediction block and the current block.

6. The apparatus of claim 5, wherein the motion compensation unit sets the motion vector of the neighboring area as a motion vector of the current block which has a same magnitude and direction as that of the motion vector of the neighboring area, and determines the corresponding area in the reference frame, which is indicated by the motion vector of the current block, as the prediction block of the current block.

7. The apparatus of claim 5, wherein the neighboring area comprises at least one block that has been encoded and reconstructed prior to the current block.

8. The apparatus of claim 5, wherein the encoding unit inserts an identifier indicating that the current block has been encoded by prediction using the motion vector of the neighboring area into a given area of a bitstream resulting from encoding the difference between the current block and the prediction block.

9. A method for video predictive decoding, the method comprising:
identifying a prediction mode of a current block to be decoded by reading prediction mode information included in an input bitstream;
if the prediction mode indicates that the current block has been predicted using a motion vector of a neighboring area located adjacent to the current block, determining the motion vector of the neighboring area by performing motion estimation with respect to the neighboring area, wherein the motion vector of the neighboring area indicates a corresponding area in a reference frame which is similar to the neighboring area;
obtaining a prediction block of the current block from the reference frame using the motion vector of the neighboring area; and
adding the prediction block of the current block to a difference between the current block and the prediction block, which is included in the input bitstream, thereby decoding the current block.

10. The method of claim 9, wherein the obtaining the prediction block of the current block comprises:
setting the motion vector of the neighboring area as a motion vector of the current block which has a same magnitude and direction as that of the determined motion vector of the neighboring area; and
determining the corresponding area in the reference frame, which is indicated by the motion vector of the current block, as the prediction block of the current block.

11. The method of claim 9, wherein the neighboring area comprises at least one block that has been decoded prior to the current block.

12. An apparatus for video predictive decoding, the apparatus comprising:
a prediction mode identification unit that identifies a prediction mode of a current block to be decoded by reading prediction mode information included in an input bitstream;
a motion estimation unit that determines a motion vector of a neighboring area located adjacent to the current block by performing motion estimation with respect to the neighboring area, wherein the motion vector of the neighboring area indicates a corresponding area in a reference frame which is similar to the neighboring area, if the prediction mode indicates that the current block has been predicted using the motion vector of the neighboring area;
a motion compensation unit that obtains a prediction block of the current block from the reference frame using the motion vector of the neighboring area; and
a decoding unit that adds the prediction block of the current block to a difference between the current block and the prediction block, which is included in the input bitstream, thereby decoding the current block.

13. The apparatus of claim 12, wherein the motion compensation unit sets the motion vector of the neighboring area as a motion vector of the current block which has a same magnitude and direction as that of the determined motion vector of the neighboring area, and determines the corresponding area in the reference frame, which is indicated by the motion vector of the current block, as the prediction block of the current block.

14. The apparatus of claim 12, wherein the neighboring area comprises at least one block that has been decoded prior to the current block.
